(19) United States
(12) Patent Application Publication
(10) Pub. No.: US 2025/0204556 A1
(43) Pub. Date: Jun. 26, 2025

(54) Enchanted Hydration Beverages with Improved Taste

(71) Applicant: The Coca-Cola Company, Atlanta, GA (US)

(72) Inventors: Nilesh Karava, Marietta, GA (US); Indra Prakash, Alpharetta, GA (US); Juvenal Higiro, Acworth, GA (US); Anuj Shanbhag, Atlanta, GA (US)

(21) Appl. No.: 18/848,338

(22) PCT Filed: Mar. 22, 2023
(86) PCT No.: PCT/US2023/064815

§ 371 Date: Sep. 18, 2024

Related U.S. Application Data
(60) Provisional application No. 63/322,736, filed on Mar. 23, 2022.

(51) Int. Cl. A23L 2/60; A23L 27/30

(52) U.S. Cl. CPC A23L 2/60; A23L 27/36

(57) ABSTRACT

Enhanced water beverages containing a steviol glycoside composition, a mogroside composition, a miracle fruit composition, and at least one vitamin and/or electrolyte are provided.

### CROSS-REFERENCE TO RELATED APPLICATION

This application claims priority to U.S. Provisional Application No. 63/322,736, filed Mar. 23, 2022. The entire content of the foregoing application is hereby incorporated herein by reference.

### FIELD OF THE INVENTION

The present invention relates generally to enhanced water beverages sweetened with stevia and monk fruit sweeteners, further containing a miracle fruit component.

### BACKGROUND OF THE INVENTION

In recent years there has been a significant increase in demand for alterative to traditional non-carbonated bottled water beverages (tap, spring, or purified), including beverages that can provide health benefits to the consumer beyond simple rehydration. Specifically, vitamin, minerals, electrolyte, and/or herb fortified beverages are of significant interest. Such beverages are referred to as “enhanced water beverages”, “near water beverages,” “functional beverages”, and “sports beverages,” among others.

The enhanced water beverages can be full-calorie (sweetened with, e.g., sucrose), mid-calorie, or zero-calorie beverages. Consumers increasingly prefer “no sugar” versions of beverages generally, and varieties of enhanced water beverages with no sucrose are available (e.g., Vitaminwater® Zero Sugar). Low or no calorie enhanced water beverages contain high potency sweeteners, including natural high potency sweeteners, to provide sweetness in the absence of sucrose. Stevia-based and monk fruit-based (Luo Han Guo) natural high potency sweeteners are popular. However, these sweeteners are known to elicit off-tastes that are objectionable to consumers and taste different than sucrose, e.g., delayed sweetness onset, lingering sweet aftertaste, bitter taste, metallic taste, astringent taste, cooling taste, licorice-like taste, watery taste, and poor mouthfeel. Additionally, flavor components of enhanced water beverage can be muted when high potency sweeteners are used.

There remains a need for enhanced water beverages sweetened with natural high potency sweeteners that have improved taste and flavor profiles.

### SUMMARY OF THE INVENTION

In one aspect, the present invention provides an enhanced water beverage comprising:
a. a steviol glycoside composition comprising a steviol glycoside in an amount of about 80% or greater by weight on a dry basis;
b. a mogroside composition selected from the group consisting of (i) monk fruit concentrate comprising at least 3.5 wt % mogroside V, (ii) siamenoside I, or (iii) monk fruit extract comprising about 45% or greater mogroside V by weight on a dry basis;
c. a miracle fruit composition in a concentration of about 5 ppm to about 60 ppm; and
d. at least one vitamin and/or electrolyte;
   wherein the steviol glycoside composition and the mogroside composition are present in a weight ratio of about 3:1 to about 1.5:1 when the mogroside composition is (ii) or (iii), and
   when the mogroside composition is (i), the monk fruit concentrate comprising at least 3.5 wt % mogroside V is present in an amount of about 0.1 to about 0.20% by weight on a dry basis.

It has been found that use certain ratios of steviol glycoside composition to mogroside composition, as well as certain concentrations of miracle fruit composition, provide improved taste and flavor profiles compared to corresponding beverages in the absence of the miracle fruit composition.

Suitable steviol glycosides include rebaudioside A, rebaudioside M, rebaudioside D, rebaudioside N, rebaudioside O, rebaudioside E, steviolmonoside, steviolbioside, rubusoside, dulcoside B, dulcoside A, rebaudioside B, rebaudioside G, stevioside, rebaudioside C, rebaudioside F, rebaudioside I, rebaudioside H, rebaudioside L, rebaudioside K, rebaudioside J, rebaudioside M2, rebaudioside D2, rebaudioside S, rebaudioside T, rebaudioside U, rebaudioside V, rebaudioside W, rebaudioside Z1, rebaudioside Z2, rebaudioside IX, and stevioside.

In one embodiment, the steviol glycoside composition is present in the beverage in a concentration from about 50 ppm to about 200 ppm, preferably from about 100 ppm to about 200 ppm, more preferably from about 150 ppm to about 200 ppm.

In embodiments where the mogroside composition is (ii) or (iii), it is present in the beverage in a concentration from about 20 ppm to about 100 ppm, preferably from about 50 ppm to about 100 ppm, more preferably from about 75 ppm to about 100 ppm.

Suitable vitamins include vitamin A, vitamin D, vitamin E, vitamin K, vitamin B1, vitamin B2, vitamin B3, vitamin B5, vitamin B6, vitamin B7, vitamin B9, vitamin B12, vitamin C, and combinations thereof.

Suitable electrolytes include sodium, potassium, calcium, magnesium, chloride, phosphate, bicarbonate, citrate, lactate, gluconate, and combinations thereof.

The enhanced water beverages also contain at least one flavor (i.e., flavor component). Suitable flavors include açai, apple, apricot, avocado, banana, blackberry, black currant, blueberry, breadfruit, cantaloupe, carambola, cherimoya, cherry, clementine, coconut, cranberry, custard-apple, date, dragonfruit, durian, elderberry, feijoa, fig, gooseberry, grapefruit, grape, guava, honeydew melon, jackfruit, java-plum, jujube fruit, kiwifruit, kumquat, lemon, lime, longan, loquat, lychee, mandarin, mango, mangosteen, mulberry, nectarine, orange, papaya, passion fruit, peach, pear, persimmon, pitaya (dragonfruit), pineapple, pitanga, plantain, plum, pomegranate, prickly pear, prune, pummelo, quince, raspberry, rhubarb, rose-apple, sapodilla, sapote, soursop, strawberry, sugar-apple, tamarind, tangerine, watermelon, chamomile, peppermint, hibiscus, lavender, marigold, chrysanthemum, ginger, turmeric, and combinations thereof.

The enhanced water beverages of the present invention preferably do not contain sucrose and have less than 10 calories per 20 US fluid ounce serving, more preferably about 5 calories or less.

### DETAILED DESCRIPTION OF THE INVENTION

### I. Definitions

“Beverage”, as used herein, refers to liquids suitable for human consumption.

“Miracle fruit composition”, as used herein, refers to a composition derived from the pulp of miracle fruit that comprises miraculin.

### II. Beverages

The present invention provides enhanced water beverages comprising a steviol glycoside composition, a mogroside composition, a miracle fruit composition, and at least one vitamin and/or electrolyte. It has been found that use certain ratios of steviol glycoside composition to mogroside composition, as well as certain concentrations of miracle fruit composition, provide improved taste and flavor profiles compared to corresponding beverages in the absence of the miracle fruit composition.

The enhanced water beverage of the present invention preferably contains from about 0 to about 10 calories per 20 US fluid ounce serving, such as, for example, from about 0 to about 5 calories.

The enhanced water beverage of the present invention preferably does not contain sucrose.

The steviol glycoside composition comprises a steviol glycoside in high purity, i.e., in an amount of about 80% or greater by weight on a dry basis, such as, for example, about 85% or greater, about 90% or greater, about 95% or greater, or about 97% or greater.

The steviol glycosides is selected from the group consisting of rebaudioside A, rebaudioside M, rebaudioside D, rebaudioside N, rebaudioside O, rebaudioside E, steviolmonoside, steviolbioside, rubusoside, dulcoside B, dulcoside A, rebaudioside B, rebaudioside G, stevioside, rebaudioside C, rebaudioside F, rebaudioside I, rebaudioside H, rebaudioside L, rebaudioside K, rebaudioside J, rebaudioside M2, rebaudioside D2, rebaudioside S, rebaudioside T, rebaudioside U, rebaudioside V, rebaudioside W, rebaudioside Z1, rebaudioside Z2, rebaudioside IX, and stevioside.

In one embodiment, the steviol glycoside is rebaudioside A. In one particular embodiment, the steviol glycoside composition comprises rebaudioside A in an amount of about 80% or greater by weight on a dry basis. In another particular embodiment, the steviol glycoside composition comprises rebaudioside A in an amount of about 95% or greater by weight on a dry basis. In still another particular embodiment, the steviol glycoside composition comprises rebaudioside A in an amount of about 99% or greater by weight on a dry basis.

In another embodiment, the steviol glycoside is rebaudioside D. In one particular embodiment, the steviol glycoside composition comprises rebaudioside D in an amount of about 80% or greater by weight on a dry basis. In another particular embodiment, the steviol glycoside composition comprises rebaudioside D in an amount of about 95% or greater by weight on a dry basis. In still another particular embodiment, the steviol glycoside composition comprises rebaudioside D in an amount of about 99% or greater by weight on a dry basis.

In another embodiment, the steviol glycoside is rebaudioside M. In one particular embodiment, the steviol glycoside composition comprises rebaudioside M in an amount of about 80% or greater by weight on a dry basis. In another particular embodiment, the steviol glycoside composition comprises rebaudioside M in an amount of about 95% or greater by weight on a dry basis. In still another particular embodiment, the steviol glycoside composition comprises rebaudioside M in an amount of about 99% or greater by weight on a dry basis.

The concentration of the steviol glycoside composition in the enhanced water beverage can vary from about 50 ppm to about 200 ppm, such as, for example, from about 500 μm to about 150 ppm, from about 50 ppm to about 100 ppm, from about 100 ppm to about 200 ppm, from about 100 ppm to about 150 ppm, and from about 150 ppm to about 200 ppm.

The mogroside composition is selected from the group consisting of monk fruit extract comprising about 45% or greater mogroside V by weight on a dry basis, siamenoside I, and monk fruit concentrate comprising at least 3.5 wt % mogroside V. All three can be commercially obtained or synthetically prepared.

In one embodiment, the mogroside composition is monk fruit extract. The monk fruit extract comprises about 45% or greater mogroside V by weight on a dry basis, such as, for example, about 50% or greater mogroside V, about 55% or greater mogroside V, about 60% or greater mogroside V, about 65% or greater mogroside V, about 70% or greater mogroside V, about 75% or greater mogroside V, about 80% or greater mogroside V, about 85% or greater mogroside V, about 90% or greater mogroside V or about 95% or greater mogroside V. In certain embodiments, the monk fruit extract comprises about 45% to about 95%, about 45% to about 90%, about 45% to about 85%, about 45% to about 80%, about 45% to about 75%, about 45% to about 70%, about 45% to about 65%, about 50% to about 95%, about 50% to about 90%, about 50% to about 85%, about 50% to about 80%, about 50% to about 75%, about 50% to about 70%, about 50% to about 65%, mogroside V by weight on a dry basis. In certain embodiments, the monk fruit extract comprises Monk Fruit 50, or a monk fruit extract that is about 50% by weight mogroside V.

Siamenoside I is a mogroside found in monk fruit extract as well. In one embodiment, the mogroside composition is siamenoside I in high purity, i.e., in an amount of about 95% or greater by weight on a dry basis.

The concentration of the mogroside composition, when provided as monk fruit extract or siamenoside I, can vary from about 20 ppm to about 100 ppm, such as, for example, from about 20 ppm to about 75 ppm, from about 20 ppm to about 50 ppm, from about 50 ppm to about 100 ppm, from about 50 ppm to about 75 ppm, and from about 75 ppm to about 100 ppm.

The weight ratio of steviol glycoside composition to mogroside composition has been found to impact the taste and flavor profile of the beverage. In certain embodiments, the weight ratio of steviol glycoside composition to mogroside composition is from about 3:1 to about 1.5:1, from about 3:1 to about 2:1, or about 2:1 to about 1.5:1.

In one embodiment, the mogroside composition is monk fruit concentrate comprising at least 3.5 wt % mogroside V, such as, for example, at least 4 wt % mogroside V, at least 5 wt % mogroside V, or at least 10 wt % mogroside V.

In embodiments where the mogroside composition is monk fruit concentrate, the concentrate is present in the beverage in an amount of about 0.1 to about 0.20 wt %, such as, for example, from about 0.1 to about 1.5 wt %.

The enhanced water beverage of the present invention also contains a miracle fruit composition. Miracle fruit or miracle berry is a plant, Synsepalum dulcificum, found in West Africa. The pulp of the miracle fruit contains a protein known as “miraculin,” which has the ability to bind to taste receptors on the human tongue, which causes humans to perceive sour as tasting sweet.

The miracle fruit composition comprises miraculin and can be in the form of miracle fruit pulp powder, fresh miracle fruit pulp, frozen miracle fruit pulp, or miracle fruit pulp concentrate. In still further embodiments, the miraculin may be obtained from synthetic sources. Various sources of miracle fruit are available. As described herein, the miracle fruit component may be any form that includes miraculin that is derived from pulp of miracle fruit.

The concentration of the miracle fruit composition in the beverage can vary from about 5 ppm to about 60 ppm, such as, for example, from about 5 ppm to about 50 ppm, from about 5 ppm to about 40 ppm, from about 5 ppm to about 30 ppm, from about 5 ppm to about 20 ppm, from about 5 ppm to about 10 ppm, from about 10 ppm to about 60 ppm, from about 10 ppm to about 50 ppm, from about 10 ppm to about 40 ppm, from about 10 ppm to about 30 ppm, from about 10 ppm to about 20 ppm, from about 20 ppm to about 60 ppm, from about 20 ppm to about 50 ppm, from about 20 ppm to about 40 ppm, from about 20 ppm to about 30 ppm, from about 30 ppm to about 60 ppm, from about 30 ppm to about 50 ppm, from about 30 ppm to about 40 ppm, from about 40 ppm to about 60 ppm, from about 40 ppm to about 50 ppm or from about 50 ppm to about 60 ppm.

The enhanced water beverage of the present invention also contains at least one vitamin and/or electrolyte.

In certain embodiments, the vitamin is selected from the group consisting of vitamin A, vitamin D, vitamin E, vitamin K, vitamin B1, vitamin B2, vitamin B3, vitamin B5, vitamin B6, vitamin B7, vitamin B9, vitamin B12, vitamin C, and combinations thereof.

Various other compounds have been classified as vitamins by some authorities. These compounds may be termed pseudo-vitamins and include, but are not limited to, compounds such as ubiquinone (coenzyme Q10), pangamic acid, dimethylglycine, taestrile, amygdaline, flavanoids, para-aminobenzoic acid, adenine, adenylic acid, and s-methylmethionine. As used herein, the term vitamin includes pseudo-vitamins. In some embodiments, the vitamin is a fat-soluble vitamin chosen from vitamin A, D, E, K and combinations thereof. In other embodiments, the vitamin is a water-soluble vitamin chosen from vitamin B1, vitamin B2, vitamin B3, vitamin B6, vitamin B12, folic acid, biotin, pantothenic acid, vitamin C and combinations thereof.

In particular embodiments, the vitamin is selected from the group consisting of vitamin A, vitamin C, vitamin E, vitamin B3, vitamin B5, vitamin B6, vitamin B12, and combinations thereof.

The electrolyte is selected from sodium, potassium, calcium, magnesium, chloride, phosphate, bicarbonate, citrate, lactate, gluconate, and combinations thereof. The electrolytes are usually, but not necessarily, obtainable from their corresponding water-soluble and non-toxic salts. Unless otherwise defined, the amount of electrolytes or ionic components in the beverage is based on those present in the final drinkable beverage composition. The electrolyte concentration is of the ion only and not the salt.

The beverages of the present invention preferably contain a total electrolyte concentration of at least about 50 mg/mL, at least about 100 mg/mL, at least about 200 mg/L, at least about 300 mg/L, at least about 400 mg/L, at least about 500 mg/L, at least about 600 mg/L, at least about 700 mg/L or at least about 800 mg/L. In a particular embodiment, the beverages contain an electrolyte concentration from about 400 mg/L to about 1,000 mg/L, from about 400 mg/L to about 900 mg/L, from about 400 mg/L to about 800 mg/L, from about 400 mg/L to about 700 mg/L, from about 400 mg/L to about 600 mg/L, from about 400 mg/L to about 500 mg/L, from about 500 mg/L to about 1,000 mg/L.

The potassium ion component can be provided by any salt including the chloride, carbonate, sulfate, acetate, bicarbonate, citrate, phosphate, hydrogen phosphate, tartrate, sorbate or a combination thereof. The potassium ions are preferably present in the beverage of the present invention in an amount of at least 0.0025% to about 0.08% by weight, from about 0.0075% to about 0.06% or from about 0.0075% to about 0.015%.

The beverage of the present invention can contain from about 5 mg/L to about 1,000 mg/L potassium, more preferably from about 50 mg/L to about 300 mg/L, such as, for example, from about 100 mg/L to about 300 mg/L, from about 200 mg/L to about 300 mg/L, from about 50 mg/L to about 200 mg/L, from about 100 mg/L to about 200 mg/L or from about 100 mg/L to about 200 mg/L potassium.

The sodium ion component can be provided by any salt such as the chloride, carbonate, sulfate, acetate, bicarbonate, citrate, phosphate, hydrogen phosphate, tartrate, sorbate or a combination thereof. The sodium ions are preferably present in the beverage of the present invention in an amount of at least about 0.005% to about 0.1% by weight, from about 0.0075% to about 0.075% or about 0.015% to about 0.05%.

The beverage of the present invention can contain from about 5 mg/L to about 1,000 mg/L sodium, more preferably from about 300 mg/L to about 800 mg/L sodium, such as, for example, from about 300 mg/L to about 700 mg/L, from about 300 mg/L to about 600 mg/L, from about 300 mg/L to about 500 mg/L, from about 300 mg/L to about 400 mg/L, from about 400 mg/L to about 800 mg/L, from about 400 mg/L to about 700 mg/L, from about 400 mg/L to about 600 mg/L from about 400 mg/L to about 500 mg/L, from about 500 mg/L to about 800 mg/L, from about 500 mg/L to about 700 mg/L, from about 500 mg/L to about 600 mg/L, from about 600 mg/L to about 800 mg/L, from about 600 mg/L to about 700 mg/L and from about 700 mg/L to about 800 mg/L. In a particular embodiment, the beverages of the present invention contain from about 600 mg/L to about 700 mg/L sodium.

The calcium ion component can be provided by any salt such as the lactate, chloride, carbonate, sulfate, acetate, bicarbonate, citrate, phosphate, hydrogen phosphate, tartrate, sorbate or a combination thereof. The calcium ions are preferably present in the beverage of the present invention in an amount of at least about 0.0005% to about 0.010% by weight.

The beverage of the present invention can contain from about 5 mg/L to about 1,000 mg/L calcium, more preferably from about 1 mg/L to about 50 mg/L, such as, for example, from about 5 mg/L to about 10 mg/L.

The magnesium ion component can be provided by any salt such as the lactate, chloride, carbonate, sulfate, acetate, bicarbonate, citrate, phosphate, hydrogen phosphate, tartrate, sorbate or a combination thereof. The magnesium ions are preferably present in the beverage of the present invention in an amount of at least about 0.0005% to about 0.010% by weight.

The beverage of the present invention can contain from about 5 mg/L to about 1,000 mg/L magnesium, more preferably from about 1 mg/L to about 50 mg/L, such as, for example, from about 5 mg/L to about 20 mg/L.

The beverage can contain chloride ion from about 0.005% to about 0.20% by weight, from about 0.01% to about 0.15% or from about 0.02% to about 0.075%. The chloride ion component can be provided by a salt such as sodium chloride, potassium chloride or a combination thereof.

In a particular embodiment, a beverage of the present invention contains at least one electrolyte selected from the group consisting of magnesium, calcium, potassium, phosphate, or combinations thereof. Magnesium and calcium are preferably supplied in the lactate forms. Potassium is preferably supplied in the form of potassium phosphate. Phosphate is preferably supplied in the form of calcium or potassium phosphate.

The enhanced water beverages of the present invention also contain at least one natural flavor, e.g., fruit or herb flavors. The flavor, or flavor component, can be provided in any suitable form.

Exemplary fruit flavors include, but are not limited to, açai, apple, apricot, avocado, banana, blackberry, black currant, blueberry, breadfruit, cantaloupe, carambola, cherimoya, cherry, clementine, coconut, cranberry, custard-apple, date, dragonfruit, durian, elderberry, feijoa, fig, gooseberry, grapefruit, grape, guava, honeydew melon, jackfruit, java-plum, jujube fruit, kiwifruit, kumquat, lemon, lime, longan, loquat, lychee, mandarin, mango, mangosteen, mulberry, nectarine, orange, papaya, passion fruit, peach, pear, persimmon, pitaya (dragonfruit), pineapple, pitanga, plantain, plum, pomegranate, prickly pear, prune, pummelo, quince, raspberry, rhubarb, rose-apple, sapodilla, sapote, soursop, strawberry, sugar-apple, tamarind, tangerine, watermelon and combinations thereof.

Exemplary herb flavors include, but are not limited to chamomile, peppermint, hibiscus, lavender, marigold, chrysanthemum, ginger, turmeric, and combinations thereof.

The enhanced water beverage of the present invention optionally contains at least one rare sugar sweetener.

Exemplary rare sugar sweeteners include, but are not limited to, allulose (D-psicose), L-ribose, D-tagatose, L-glucose, L-fucose, L-arabinose, D-turanose, D-leubiose (D-leucose), and combinations thereof.

The enhanced water beverage of the present invention optionally contains at least one sugar alcohol sweetener.

The amount of rare sugar sweetener in the beverage depends on the identity of the rare sugar and the permitted regulatory limit. In one embodiment, a beverage comprises a rare sugar in an amount from about 0.1 wt % to 12 wt %, from about 0.1 wt % to about 5 wt %, from about 0.1 wt % to about 2.5 wt %, about 0.1 wt % to about 2 wt %, or about 0.1 wt % to about 1 wt %.

Exemplary sugar alcohols include, but are not limited to, sorbitol, mannitol, lactitol, maltitol, xylitol, erythritol and combinations thereof. In one embodiment, the sugar alcohol is sorbitol. In one embodiment, the sugar alcohol is mannitol. In one embodiment, the sugar alcohol is lactitol. In one embodiment, the sugar alcohol is maltitol. In one embodiment, the sugar alcohol is xylitol. In one embodiment, the sugar alcohol is erythritol. In one embodiment, the sugar alcohol comprises two or more sugar alcohols.

The at least one sugar alcohol can be present the beverages in an amount from about 0.1 wt % to about 8 wt %, such as, for example, from about 1 wt % to about 8 wt %, from about 1 wt % to about 5 wt %, from about 1 wt % to about 3 wt %, from about 3 wt % to about 8 wt %, from about 3 wt % to about 5 wt % or from about 5 wt % to about 8 wt %.

The enhanced water beverages comprise a beverage matrix, i.e., the basic ingredient in which the ingredients are dissolved. In one embodiment, a beverage comprises water of beverage quality as the matrix, such as, for example deionized water, distilled water, reverse osmosis water, carbon-treated water, purified water, demineralized water and combinations thereof, can be used. Additional suitable beverage matrices ingredients include, but are not limited to phosphoric acid, phosphate buffer, citric acid, citrate buffer and carbon-treated water.

A non-limiting example of the pH range of the enhanced water beverage may be from about 1.8 to about 10. A further example includes a pH range from about 2 to about 5. In a particular embodiment, the pH of beverage can be from about 2.5 to about 4.2.

The enhanced water beverages can be caffeinated (i.e., it contains caffeine) or non-caffeinated.

The temperature of the enhanced water beverage may, for example, range from about 4° C. to about 100° C., such as, for example, from about 4° C. to about 25° C.

The enhanced water beverage has a sucrose equivalence (SE) of about 0.7% (w/v), such as, for example, about 1% (w/v), about 2%, about 3%, about 4%, about 5%, about 6%, about 7%, about 8%, about 9%, about 10%, about 11%, about 12%, about 13%, about 14% or any range between these values. In a particular embodiment, the enhanced water beverage has a sucrose equivalence of from about 0.7% to about 2%, or from about 0.7% to about 1%.

### A. Formulations

In one embodiment, an enhanced water beverage comprises a steviol glycoside composition, a mogroside composition, a miracle fruit composition, and at least one vitamin and/or electrolyte.

In one embodiment, an enhanced water beverage comprises a steviol glycoside composition comprising rebaudioside A, a mogroside composition comprising monk fruit extract, a miracle fruit composition comprising miraculin, and at least one vitamin and/or electrolyte. In one embodiment, an enhanced water beverage comprises rebaudioside A, monk fruit extract, miraculin, and at least one vitamin and/or electrolyte.

In certain embodiments, the steviol glycoside composition comprises rebaudioside A in an amount of about 80% to about 99%, about 85% to about 99%, about 90% to about 99%, about 90% to about 97%, about 93% to about 97%, or about 95% to about 99%, by weight on a dry basis.

In certain embodiments, the steviol glycoside composition comprising rebaudioside A is present in the enhanced water beverage in an amount in the range of about 125 ppm to about 175 ppm, or about 140 to about 160 ppm.

In certain embodiments, the mogroside composition comprises monk fruit extract which comprises mogroside V in an amount of about 45% to about 85%, about 45% to about 55%, about 50% to about 80%, or about 75% to about 85%, by weight on a dry basis.

In certain embodiments, the monk fruit extract, for example Monk Fruit 50 or Monk Fruit 80, is present in the enhanced water beverage is an amount in the range of about 20 to about 100 ppm, about 45 to about 55 ppm, about 40 to about 60 ppm, about 50 to about 75 ppm, or about 45 to about 80 ppm.

In certain embodiments, the miracle fruit composition comprises miracle fruit powder in an amount of about 5 to about 25 ppm, or about 5 to about 15 ppm.

In a particular embodiment, an enhanced water beverage comprises a steviol glycoside composition comprising rebaudioside A in an amount of about 80% or greater by weight on a dry basis; a mogroside composition that is monk fruit extract comprising about 45% or greater mogroside V by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In a particular embodiment, an enhanced water beverage comprises a steviol glycoside composition comprising rebaudioside A in an amount of about 80% or greater by weight on a dry basis; a mogroside composition that is monk fruit extract comprising about 45% or greater mogroside V by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof; wherein the weight ratio of steviol glycoside composition to mogroside composition is from about 3:1 to about 1.5:1.

In another particular embodiment, an enhanced water beverage comprises from about 50 ppm to about 200 ppm, about 150 ppm to about 200 ppm, or about 125 ppm to about 175 ppm of a steviol glycoside composition comprising rebaudioside A in an amount of about 80% or greater by weight on a dry basis; from about 20 ppm to about 100 ppm of a mogroside composition that is monk fruit extract comprising about 45% or greater mogroside V by weight on a dry basis; from about 5 ppm to about 60 ppm of a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises a steviol glycoside composition comprising rebaudioside A in an amount of about 80% or greater by weight on a dry basis; a mogroside composition that is siamenoside I in an amount of about 95% or greater by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises a steviol glycoside composition comprising rebaudioside A in an amount of about 80% or greater by weight on a dry basis; a mogroside composition that is siamenoside I in an amount of about 95% or greater by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof; wherein the weight ratio of steviol glycoside composition to mogroside composition is from about 3:1 to about 1.5:1.

In another particular embodiment, an enhanced water beverage comprises from about 50 ppm to about 200 ppm, preferably from about 150 ppm to about 200 ppm of a steviol glycoside composition comprising rebaudioside A in an amount of about 80% or greater by weight on a dry basis; from about 20 ppm to about 100 ppm of a mogroside composition that is siamenoside I in an amount of about 95% or greater by weight on a dry basis; from about 5 ppm to about 6 ppm of a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises a steviol glycoside composition comprising rebaudioside A in an amount of about 80% or greater by weight on a dry basis; a mogroside composition that is monk fruit concentrate comprising at least 3.5 wt % mogroside V; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises from about 50 ppm to about 200 ppm, preferably from about 150 ppm to about 200 ppm of a steviol glycoside composition comprising rebaudioside A in an amount of about 80% or greater by weight on a dry basis; from about 0.1 to about 0.20 wt % of a mogroside composition that is monk fruit concentrate comprising at least 3.5 wt % mogroside V; from about 5 ppm to about 60 ppm of a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In a particular embodiment, an enhanced water beverage comprises a steviol glycoside composition comprising rebaudioside D in an amount of about 80% or greater by weight on a dry basis; a mogroside composition that is monk fruit extract comprising about 45% or greater mogroside V by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In a particular embodiment, an enhanced water beverage comprises a steviol glycoside composition comprising rebaudioside D in an amount of about 80% or greater by weight on a dry basis; a mogroside composition that is monk fruit extract comprising about 45% or greater mogroside V by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof; wherein the weight ratio of steviol glycoside composition to mogroside composition is from about 3:1 to about 1.5:1.

In another particular embodiment, an enhanced water beverage comprises from about 50 ppm to about 200 ppm, preferably from about 150 ppm to about 200 ppm, of a steviol glycoside composition comprising rebaudioside D in an amount of about 80% or greater by weight on a dry basis; from about 20 ppm to about 100 ppm of a mogroside composition that is monk fruit extract comprising about 45% or greater mogroside V by weight on a dry basis; from about 5 ppm to about 60 ppm of a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises a steviol glycoside composition comprising rebaudioside D in an amount of about 80% or greater by weight on a dry basis; a mogroside composition that is siamenoside I in an amount of about 95% or greater by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises a steviol glycoside composition comprising rebaudioside D in an amount of about 80% or greater by weight on a dry basis; a mogroside composition that is siamenoside I in an amount of about 95% or greater by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof; wherein the weight ratio of steviol glycoside composition to mogroside composition is from about 3:1 to about 1.5:1.

In another particular embodiment, an enhanced water beverage comprises from about 50 ppm to about 200 ppm, preferably from about 150 ppm to about 200 ppm of a steviol glycoside composition comprising rebaudioside D in an amount of about 80% or greater by weight on a dry basis; from about 20 ppm to about 100 ppm of a mogroside composition that is siamenoside I in an amount of about 95% or greater by weight on a dry basis; from about 5 ppm to about 6 ppm of a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises a steviol glycoside composition comprising rebaudioside D in an amount of about 80% or greater by weight on a dry basis; a mogroside composition that is monk fruit concentrate comprising at least 3.5 wt % mogroside V; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises from about 50 ppm to about 200 ppm, preferably from about 150 ppm to about 200 ppm of a steviol glycoside composition comprising rebaudioside D in an amount of about 80% or greater by weight on a dry basis; from about 0.1 to about 0.20 wt % of a mogroside composition that is monk fruit concentrate comprising at least 3.5 wt % mogroside V; from about 5 ppm to about 60 ppm of a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In a particular embodiment, an enhanced water beverage comprises a steviol glycoside composition comprising rebaudioside M in an amount of about 80% or greater by weight on a dry basis; a mogroside composition that is monk fruit extract comprising about 45% or greater mogroside V by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In a particular embodiment, an enhanced water beverage comprises a steviol glycoside composition comprising rebaudioside M in an amount of about 80% or greater by weight on a dry basis; a mogroside composition that is monk fruit extract comprising about 45% or greater mogroside V by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof; wherein the weight ratio of steviol glycoside composition to mogroside composition is from about 3:1 to about 1.5:1.

In another particular embodiment, an enhanced water beverage comprises from about 50 ppm to about 200 ppm, preferably from about 150 ppm to about 200 ppm, of a steviol glycoside composition comprising rebaudioside M in an amount of about 80% or greater by weight on a dry basis; from about 20 ppm to about 100 ppm of a mogroside composition that is monk fruit extract comprising about 45% or greater mogroside V by weight on a dry basis; from about 5 ppm to about 60 ppm of a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises a steviol glycoside composition comprising rebaudioside M in an amount of about 80% or greater by weight on a dry basis; a mogroside composition that is siamenoside I in an amount of about 95% or greater by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises a steviol glycoside composition comprising rebaudioside M in an amount of about 80% or greater by weight on a dry basis; a mogroside composition that is siamenoside I in an amount of about 95% or greater by weight on a dry basis; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof; wherein the weight ratio of steviol glycoside composition to mogroside composition is from about 3:1 to about 1.5:1.

In another particular embodiment, an enhanced water beverage comprises from about 50 ppm to about 200 ppm, preferably from about 150 ppm to about 200 ppm of a steviol glycoside composition comprising rebaudioside M in an amount of about 80% or greater by weight on a dry basis; from about 20 ppm to about 100 ppm of a mogroside composition that is siamenoside I in an amount of about 95% or greater by weight on a dry basis; from about 5 ppm to about 6 ppm of a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises a steviol glycoside composition comprising rebaudioside M in an amount of about 80% or greater by weight on a dry basis; a mogroside composition that is monk fruit concentrate comprising at least 3.5 wt % mogroside V; a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

In another particular embodiment, an enhanced water beverage comprises from about 50 ppm to about 200 ppm, preferably from about 150 ppm to about 200 ppm of a steviol glycoside composition comprising rebaudioside M in an amount of about 80% or greater by weight on a dry basis; from about 0.1 to about 0.20 wt % of a mogroside composition that is monk fruit concentrate comprising at least 3.5 wt % mogroside V; from about 5 ppm to about 60 ppm of a miracle fruit composition comprising miraculin; at least one vitamin selected from the group consisting of vitamin A, vitamin D, vitamin E, vitamin K, vitamin B1, vitamin B2, vitamin B3, vitamin B5, vitamin B6, vitamin B7, vitamin B9, vitamin B12, and vitamin C, and combinations thereof; and at least one electrolyte selected from the group consisting of sodium, potassium, calcium, magnesium, chloride, phosphate, bicarbonate, citrate, lactate, gluconate, and combinations thereof.

### B. Functional Ingredients

The enhanced water beverages described herein optionally include at least one functional ingredient described herein below.

Exemplary functional ingredients include, but are not limited to, saponins, antioxidants, dietary fiber sources, fatty acids, vitamins, glucosamine, minerals, preservatives, hydration agents, probiotics, prebiotics, weight management agents, osteoporosis management agents, phytoestrogens, long chain primary aliphatic saturated alcohols, phytosterols and combinations thereof.

In certain embodiments, the functional ingredient is at least one saponin. As used herein, the at least one saponin may comprise a single saponin or a plurality of saponins as a functional ingredient for the composition provided herein. Saponins are glycosidic natural plant products comprising an aglycone ring structure and one or more sugar moieties. Non-limiting examples of specific saponins for use in particular embodiments of the invention include group A acetyl saponin, group B acetyl saponin, and group E acetyl saponin. Several common sources of saponins include soybeans, which have approximately 5% saponin content by dry weight, soapwort plants (Saponara), the root of which was used historically as soap, as well as alfalfa, aloe, asparagus, grapes, chickpeas, yucca, and various other beans and weeds. Saponins may be obtained from these sources by using extraction techniques well known to those of ordinary skill in the art. A description of conventional extraction techniques can be found in U.S. Pat. Appl. No. 2005/0123662.

In certain embodiments, the functional ingredient is at least one antioxidant. As used herein, “antioxidant” refers to any substance which inhibits, suppresses, or reduces oxidative damage to cells and biomolecules.

Examples of suitable antioxidants for embodiments of this invention include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, α-carotene, β-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example. Other sources of suitable antioxidants for embodiments of this invention include, but are not limited to, fruits, vegetables, tea, cocoa, chocolate, spices, herbs, rice, organ meats from livestock, yeast, whole grains, or cereal grains.

Particular antioxidants belong to the class of phytonutrients called polyphenols (also known as “polyphenolics”), which are a group of chemical substances found in plants, characterized by the presence of more than one phenol group per molecule. Suitable polyphenols for embodiments of this invention include catechins, proanthocyanidins, procyanidins, anthocyanins, quercerin, rutin, reservatrol, isoflavones, curcumin, punicalagin, ellagitannin, hesperidin, naringin, citrus flavonoids, chlorogenic acid, other similar materials, and combinations thereof.

In one embodiment, the antioxidant is a catechin such as, for example, epigallocatechin gallate (EGCG). In another embodiment, the antioxidant is chosen from proanthocyanidins, procyanidins or combinations thereof. In particular embodiments, the antioxidant is an anthocyanin. In still other embodiments, the antioxidant is chosen from quercetin, rutin or combinations thereof. In one embodiment, the antioxidant is reservatrol. In another embodiment, the antioxidant is an isoflavone. In still another embodiment, the antioxidant is curcumin. In a yet further embodiment, the antioxidant is chosen from punicalagin, ellagitannin or combinations thereof. In a still further embodiment, the antioxidant is chlorogenic acid.

In certain embodiments, the functional ingredient is at least one dietary fiber. Numerous polymeric carbohydrates having significantly different structures in both composition and linkages fall within the definition of dietary fiber. Such compounds are well known to those skilled in the art, non-limiting examples of which include non-starch polysaccharides, lignin, cellulose, methylcellulose, the hemicelluloses, s-glucans, pectins, gums, mucilage, waxes, inulins, oligosaccharides, fructooligosaccharides, cyclodextrins, chitins, and combinations thereof. Although dietary fiber generally is derived from plant sources, indigestible animal products such as chitins are also classified as dietary fiber. Chitin is a polysaccharide composed of units of acetylglucosamine joined by β(1-4) linkages, similar to the linkages of cellulose.

In certain embodiments, the functional ingredient is at least one fatty acid. As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” any polyunsaturated fatty acid having a first double bond as the sixth carbon-carbon bond from the terminal methyl end of its carbon chain.

Suitable omega-3 fatty acids for use in embodiments of the present invention can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils such as Microalgae DHA oil (from Martek, Columbia, MD), OmegaPure (from Omega Protein, Houston, TX), Marinol C-38 (from Lipid Nutrition, Channahon, IL), Bonito oil and MEG-3 (from Ocean Nutrition, Dartmouth, NS), Evogel (from Symrise, Holzminden, Germany), Marine Oil, from tuna or salmon (from Arista Wilton, CT), OmegaSource 2000, Marine Oil, from menhaden and Marine Oil, from cod (from OmegaSource, RTP, NC).

Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof.

Suitable esterified fatty acids for embodiments of the present invention include, but are not limited to, monoacylgycerols containing omega-3 and/or omega-6 fatty acids, diacylgycerols containing omega-3 and/or omega-6 fatty acids, or triacylgycerols containing omega-3 and/or omega-6 fatty acids and combinations thereof.

In certain embodiments, the functional ingredient is glucosamine, optionally further comprising chondroitin sulfate.

In certain embodiments, the functional ingredient is at least one preservative. In particular embodiments, the preservative is chosen from antimicrobials, antioxidants, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, and ozone. In one embodiment, the preservative is a sulfite. Sulfites include, but are not limited to, sulfur dioxide, sodium bisulfite, and potassium hydrogen sulfite. In another embodiment, the preservative is a propionate. Propionates include, but are not limited to, propionic acid, calcium propionate, and sodium propionate. In yet another embodiment, the preservative is a benzoate. Benzoates include, but are not limited to, sodium benzoate and benzoic acid. In still another embodiment, the preservative is a sorbate. Sorbates include, but are not limited to, potassium sorbate, sodium sorbate, calcium sorbate, and sorbic acid. In a still further embodiment, the preservative is a nitrate and/or a nitrite. Nitrates and nitrites include, but are not limited to, sodium nitrate and sodium nitrite. In another embodiment, the at least one preservative is a bacteriocin, such as, for example, nisin. In still another embodiment, the preservative is ethanol. In yet another embodiment, the preservative is ozone. Non-limiting examples of antienzymatics suitable for use as preservatives in particular embodiments of the invention include ascorbic acid, citric acid, and metal chelating agents such as ethylenediaminetetraacetic acid (EDTA).

In certain embodiments, the functional ingredient is at least one hydration agent. In another particular embodiment, the hydration agent is a carbohydrate to supplement energy stores burned by muscles. Suitable carbohydrates for use in particular embodiments of this invention are described in U.S. Pat. Nos. 4,312,856, 4,853,237, 5,681,569, and 6,989,171. Non-limiting examples of suitable carbohydrates include monosaccharides, disaccharides, oligosaccharides, complex polysaccharides or combinations thereof. Non-limiting examples of suitable types of monosaccharides for use in particular embodiments include trioses, tetroses, pentoses, hexoses, heptoses, octoses, and nonoses. Non-limiting examples of specific types of suitable monosaccharides include glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, and sialose. Non-limiting examples of suitable disaccharides include sucrose, lactose, and maltose. Non-limiting examples of suitable oligosaccharides include saccharose, maltotriose, and maltodextrin. In other particular embodiments, the carbohydrates are provided by a corn syrup, a beet sugar, a cane sugar, a juice, or a tea.

In another particular embodiment, the hydration agent is a flavanol that provides cellular rehydration. Flavanols are a class of natural substances present in plants, and generally comprise a 2-phenylbenzopyrone molecular skeleton attached to one or more chemical moieties. Non-limiting examples of suitable flavanols for use in particular embodiments of this invention include catechin, epicatechin, gallocatechin, epigallocatechin, epicatechin gallate, epigallocatechin 3-gallate, theaflavin, theaflavin 3-gallate, theaflavin 3′-gallate, theaflavin 3,3′ gallate, thearubigin or combinations thereof. Several common sources of flavanols include tea plants, fruits, vegetables, and flowers. In preferred embodiments, the flavanol is extracted from green tea.

In a particular embodiment, the hydration agent is a glycerol solution to enhance exercise endurance. The ingestion of a glycerol containing solution has been shown to provide beneficial physiological effects, such as expanded blood volume, lower heart rate, and lower rectal temperature.

In certain embodiments, the functional ingredient is chosen from at least one probiotic, prebiotic and combination thereof. The probiotic is a beneficial microorganism that affects the human body's naturally-occurring gastrointestinal microflora. Examples of probiotics include, but are not limited to, bacteria of the genus Lactobacilli, Bifidobactera, Streptococci, or combinations thereof, that confer beneficial effects to humans. In particular embodiments of the invention, the at least one probiotic is chosen from the genus Lactobacilli. According to other particular embodiments of this invention, the probiotic is chosen from the genus Bifidobacteria. In a particular embodiment, the probiotic is chosen from the genus Streptococcus.

Probiotics that may be used in accordance with this invention are well-known to those of skill in the art. Non-limiting examples of foodstuffs comprising probiotics include yogurt, sauerkraut, kefir, kimchi, fermented vegetables, and other foodstuffs containing a microbial element that beneficially affects the host animal by improving the intestinal microbalance.

Prebiotics, in accordance with the embodiments of this invention, include, without 10 limitation, mucopolysaccharides, oligosaccharides, polysaccharides, amino acids, vitamins, nutrient precursors, proteins and combinations thereof. According to a particular embodiment of this invention, the prebiotic is chosen from dietary fibers, including, without limitation, polysaccharides and oligosaccharides. Non-limiting examples of oligosaccharides that are categorized as prebiotics in accordance with particular embodiments of this invention include fructooligosaccharides, inulins, isomalto-oligosaccharides, lactilol, lactosucrose, lactulose, pyrodextrins, soy oligosaccharides, transgalacto-oligosaccharides, and xylo-oligosaccharides. In other embodiments, the prebiotic is an amino acid. Although a number of known prebiotics break down to provide carbohydrates for probiotics, some probiotics also require amino acids for nourishment.

Prebiotics are found naturally in a variety of foods including, without limitation, bananas, berries, asparagus, garlic, wheat, oats, barley (and other whole grains), flaxseed, tomatoes, Jerusalem artichoke, onions and chicory, greens (e.g., dandelion greens, spinach, collard greens, chard, kale, mustard greens, turnip greens), and legumes (e.g., lentils, kidney beans, chickpeas, navy beans, white beans, black beans).

In certain embodiments, the functional ingredient is at least one weight management agent. As used herein, “a weight management agent” includes an appetite suppressant and/or a thermogenesis agent. As used herein, the phrases “appetite suppressant”, “appetite satiation compositions”, “satiety agents”, and “satiety ingredients” are synonymous. The phrase “appetite suppressant” describes macronutrients, herbal extracts, exogenous hormones, anorectics, anorexigenics, pharmaceutical drugs, and combinations thereof, that when delivered in an effective amount, suppress, inhibit, reduce, or otherwise curtail a person's appetite. The phrase “thermogenesis agent” describes macronutrients, herbal extracts, exogenous hormones, anorectics, anorexigenics, pharmaceutical drugs, and combinations thereof, that when delivered in an effective amount, activate or otherwise enhance a person's thermogenesis or metabolism.

Suitable weight management agents include macronutrients selected from the group consisting of proteins, carbohydrates, dietary fats, and combinations thereof. Consumption of proteins, carbohydrates, and dietary fats stimulates the release of peptides with appetite-suppressing effects. For example, consumption of proteins and dietary fats stimulates the release of the gut hormone cholecytokinin (CCK), while consumption of carbohydrates and dietary fats stimulates release of Glucagon-like peptide 1 (GLP-1).

Suitable macronutrient weight management agents also include carbohydrates. Carbohydrates generally comprise sugars, starches, cellulose and gums that the body converts into glucose for energy. Carbohydrates often are classified into two categories, digestible carbohydrates (e.g., monosaccharides, disaccharides, and starch) and non-digestible carbohydrates (e.g., dietary fiber). Studies have shown that non-digestible carbohydrates and complex polymeric carbohydrates having reduced absorption and digestibility in the small intestine stimulate physiologic responses that inhibit food intake. Accordingly, the carbohydrates embodied herein desirably comprise non-digestible carbohydrates or carbohydrates with reduced digestibility. Non-limiting examples of such carbohydrates include polydextrose; inulin; monosaccharide-derived polyols such as erythritol, mannitol, xylitol, and sorbitol; disaccharide-derived alcohols such as isomalt, lactitol, and maltitol; and hydrogenated starch hydrolysates. Carbohydrates are described in more detail herein below.

In another particular embodiment, the weight management agent is a dietary fat. Dietary fats are lipids comprising combinations of saturated and unsaturated fatty acids. Polyunsaturated fatty acids have been shown to have a greater satiating power than mono-unsaturated fatty acids. Accordingly, the dietary fats embodied herein desirably comprise polyunsaturated fatty acids, non-limiting examples of which include triacylglycerols.

In another particular embodiment, the weight management agent is an herbal extract. Extracts from numerous types of plants have been identified as possessing appetite suppressant properties. Non-limiting examples of plants whose extracts have appetite suppressant properties include plants of the genus Hoodia, Trichocaulon, Caralluma, Stapelia, Orbea, Asclepias, and Camelia. Other embodiments include extracts derived from Gymnema Sylvestre, Kola Nut, Citrus Auran tium, Yerba Mate, Griffonia Simplicifolia, Guarana, myrrh, guggul Lipid, and black current seed oil.

The herbal extracts may be prepared from any type of plant material or plant biomass. Non-limiting examples of plant material and biomass include the stems, roots, leaves, dried powder obtained from the plant material, and sap or dried sap. The herbal extracts generally are prepared by extracting sap from the plant and then spray-drying the sap. Alternatively, solvent extraction procedures may be employed. Following the initial extraction, it may be desirable to further fractionate the initial extract (e.g., by column chromatography) in order to obtain an herbal extract with enhanced activity. Such techniques are well known to those of ordinary skill in the art.

In one embodiment, the herbal extract is derived from a plant of the genus Hoodia. A sterol glycoside of Hoodia, known as P57, is believed to be responsible for the appetite-suppressant effect of the Hoodia species. In another embodiment, the herbal extract is derived from a plant of the genus Caralluma, non-limiting examples of which include caratuberside A, caratuberside B, bouceroside I, bouceroside II, bouceroside Ill, bouceroside IV, bouceroside V, bouceroside VI, bouceroside VII, bouceroside VIII, bouceroside IX, and bouceroside X. In another embodiment, the at least one herbal extract is derived from a plant of the genus Trichocaulon. Trichocaulon plants are succulents that generally are native to southern Africa, similar to Hoodia, and include the species T. piliferum and T. officinale. In another embodiment, the herbal extract is derived from a plant of the genus Stapelia or Orbea. Not wishing to be bound by any theory, it is believed that the compounds exhibiting appetite suppressant activity are saponins, such as pregnane glycosides, which include stavarosides A, B, C, D, E, F, G, H, I, J, and K. In another embodiment, the herbal extract is derived from a plant of the genus Asdepias. Not wishing to be bound by any theory, it is believed that the extracts comprise steroidal compounds, such as pregnane glycosides and pregnane aglycone, having appetite suppressant effects.

In another particular embodiment, the weight management agent is an exogenous hormone having a weight management effect. Non-limiting examples of such hormones include CCK, peptide YY, ghrelin, bombesin and gastrin-releasing peptide (GRP), enterostatin, apolipoprotein A-IV, GLP-1, amylin, somastatin, and leptin.

In another embodiment, the weight management agent is a pharmaceutical drug. Non-limiting examples include phentenime, diethylpropion, phendimetrazine, sibutramine, rimonabant, oxyntomodulin, floxetine hydrochloride, ephedrine, phenethylamine, or other stimulants.

In certain embodiments, the functional ingredient is at least one osteoporosis management agent. In certain embodiments, the osteoporosis management agent is at least one calcium source. According to a particular embodiment, the calcium source is any compound containing calcium, including salt complexes, solubilized species, and other forms of calcium. Non-limiting examples of calcium sources include amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium citrate malate, calcium gluconate, calcium tartrate, calcium lactate, solubilized species thereof, and combinations thereof.

According to a particular embodiment, the osteoporosis management agent is a magnesium source. The magnesium source is any compound containing magnesium, including salt complexes, solubilized species, and other forms of magnesium. Non-limiting examples of magnesium sources include magnesium chloride, magnesium citrate, magnesium gluceptate, magnesium gluconate, magnesium lactate, magnesium hydroxide, magnesium picolate, magnesium sulfate, solubilized species thereof, and mixtures thereof. In another particular embodiment, the magnesium source comprises an amino acid chelated or creatine chelated magnesium.

In other embodiments, the osteoporosis agent is chosen from vitamins D, C, K, their precursors and/or beta-carotene and combinations thereof.

Numerous plants and plant extracts also have been identified as being effective in the prevention and treatment of osteoporosis. Non-limiting examples of suitable plants and plant extracts as osteoporosis management agents include species of the genus Taraxacum and Amelanchier, as disclosed in U.S. Patent Publication No. 2005/0106215, and species of the genus Lindera, Artemisia, Acorus, Carthamus, Carum, Cnidium, Curcuma, Cyperus, Juniperus, Prunus, Iris, Cichorium, Dodonaea, Epimedium, Erigonoum, Soya, Mentha, Ocimum, thymus, Tanacetum, Plantago, Spearmint, Bixa, Vitis, Rosemarinus, Rhus, and Anethum, as disclosed in U.S. Patent Publication No. 2005/0079232.

In certain embodiments, the functional ingredient is at least one phytoestrogen. Phytoestrogens are compounds found in plants which can typically be delivered into human bodies by ingestion of the plants or the plant parts having the phytoestrogens. As used herein, “phytoestrogen” refers to any substance which, when introduced into a body causes an estrogen-like effect of any degree. For example, a phytoestrogen may bind to estrogen receptors within the body and have a small estrogen-like effect.

Examples of suitable phytoestrogens for embodiments of this invention include, but are not limited to, isoflavones, stilbenes, lignans, resorcyclic acid lactones, coumestans, coumestrol, equol, and combinations thereof. Sources of suitable phytoestrogens include, but are not limited to, whole grains, cereals, fibers, fruits, vegetables, black cohosh, agave root, black currant, black haw, chasteberries, cramp bark, dong quai root, devil's club root, false unicorn root, ginseng root, groundsel herb, licorice, liferoot herb, motherwort herb, peony root, raspberry leaves, rose family plants, sage leaves, sarsaparilla root, saw palmetto berried, wild yam root, yarrow blossoms, legumes, soybeans, soy products (e.g., miso, soy flour, soymilk, soy nuts, soy protein isolate, tempen, or tofu) chick peas, nuts, lentils, seeds, clover, red clover, dandelion leaves, dandelion roots, fenugreek seeds, green tea, hops, red wine, flaxseed, garlic, onions, linseed, borage, butterfly weed, caraway, chaste tree, vitex, dates, dill, fennel seed, gotu kola, milk thistle, pennyroyal, pomegranates, southernwood, soya flour, tansy, and root of the kudzu vine (pueraria root) and the like, and combinations thereof.

Isoflavones belong to the group of phytonutrients called polyphenols. In general, polyphenols (also known as “polyphenolics”), are a group of chemical substances found in plants, characterized by the presence of more than one phenol group per molecule.

Suitable phytoestrogen isoflavones in accordance with embodiments of this invention include genistein, daidzein, glycitein, biochanin A, formononetin, their respective naturally occurring glycosides and glycoside conjugates, matairesinol, secoisolariciresinol, enterolactone, enterodiol, textured vegetable protein, and combinations thereof.

Suitable sources of isoflavones for embodiments of this invention include, but are not limited to, soy beans, soy products, legumes, alfalfa sprouts, chickpeas, peanuts, and red clover.

In certain embodiments, the functional ingredient is at least one long chain primary aliphatic saturated alcohol. Long-chain primary aliphatic saturated alcohols are a diverse group of organic compounds. The term alcohol refers to the fact these compounds feature a hydroxyl group (—OH) bound to a carbon atom. Non-limiting examples of particular long-chain primary aliphatic saturated alcohols for use in particular embodiments of the invention include the 8 carbon atom 1-octanol, the 9 carbon 1-nonanol, the 10 carbon atom 1-decanol, the 12 carbon atom 1-dodecanol, the 14 carbon atom 1-tetradecanol, the 16 carbon atom 1-hexadecanol, the 18 carbon atom 1-octadecanol, the 20 carbon atom I-eicosanol, the 22 carbon 1-docosanol, the 24 carbon 1-tetracosanol, the 26 carbon 1-hexacosanol, the 27 carbon 1-heptacosanol, the 28 carbon 1-octanosol, the 29 carbon 1-nonacosanol, the 30 carbon 1-triacontanol, the 32 carbon 1-dotriacontanol, and the 34 carbon 1-tetracontanol.

In one embodiment, the long-chain primary aliphatic saturated alcohol is a policosanol. Policosanol is the term for a mixture of long-chain primary aliphatic saturated alcohols composed primarily of 28 carbon 1-octanosol and 30 carbon 1-triacontanol, as well as other alcohols in lower concentrations such as 22 carbon 1-docosanol, 24 carbon 1-tetracosanol, 26 carbon 1-hexacosanol, 27 carbon 1-heptacosanol, 29 carbon 1-nonacosanol, 32 carbon 1-dotriacontanol, and 34 carbon 1-tetracontanol.

In certain embodiments, the functional ingredient is at least one phytosterol, phytostanol or combination thereof. As used herein, the phrases “stanol”, “plant stanol” and “phytostanol” are synonymous. Plant sterols and stanols are present naturally in small quantities in many fruits, vegetables, nuts, seeds, cereals, legumes, vegetable oils, bark of the trees and other plant sources. Sterols are a subgroup of steroids with a hydroxyl group at C-3. Generally, phytosterols have a double bond within the steroid nucleus, like cholesterol; however, phytosterols also may comprise a substituted side chain (R) at C-24, such as an ethyl or methyl group, or an additional double bond. The structures of phytosterols are well known to those of skill in the art.

At least 44 naturally-occurring phytosterols have been discovered, and generally are derived from plants, such as corn, soy, wheat, and wood oils; however, they also may be produced synthetically to form compositions identical to those in nature or having properties similar to those of naturally-occurring phytosterols. Non-limiting suitable phytosterols include, but are not limited to, 4-desmethylsterols (e.g., β-sitosterol, campesterol, stigmasterol, brassicasterol, 22-dehydrobrassicasterol, and Δr-avenasterol), 4-monomethyl sterols, and 4,4-dimethyl sterols (triterpene alcohols) (e.g., cycloartenol, 24-methylenecycloartanol, and cyclobranol).

As used herein, the phrases “stanol”, “plant stanol” and “phytostanol” are synonymous.

Phytostanols are saturated sterol alcohols present in only trace amounts in nature and also may be synthetically produced, such as by hydrogenation of phytosterols. Suitable phytostanols include, but are not limited to, β-sitostanol, campestanol, cycloartanol, and saturated forms of other triterpene alcohols.

Both phytosterols and phytostanols, as used herein, include the various isomers such as the α and β isomers. The phytosterols and phytostanols of the present invention also may be in their ester form. Suitable methods for deriving the esters of phytosterols and phytostanols are well known to those of ordinary skill in the art, and are disclosed in U.S. Pat. Nos. 6,589,588, 6,635,774, 6,800,317, and U.S. Patent Publication Number 2003/0045473. Non-limiting examples of suitable phytosterol and phytostanol esters include sitosterol acetate, sitosterol oleate, stigmasterol oleate, and their corresponding phytostanol esters. The phytosterols and phytostanols of the present invention also may include their derivatives.

### C. Additives

The enhanced water beverages described herein can further include at least one additive. Exemplary additives include, but not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, caffeine, flavorants and flavoring ingredients, astringent compounds, proteins or protein hydrolysates, surfactants, emulsifiers, plant extracts, flavonoids, alcohols, polymers and combinations thereof.

The term “polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group. Non-limiting examples of polyols in some embodiments include maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect taste.

Suitable amino acid additives include, but are not limited to, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, ornithine, methionine, camitine, aminobutyric acid (α-, β-, and/or δ-isomers), glutamine, hydroxyproline, taurine, norvaline, sarcosine, and their salt forms such as sodium or potassium salts or acid salts. The amino acid additives also may be in the D- or L-configuration and in the mono-, di-, or tri-form of the same or different amino acids. Additionally, the amino acids may be α-, β-, γ and/or δ-isomers if appropriate. Combinations of the foregoing amino acids and their corresponding salts (e.g., sodium, potassium, calcium, magnesium salts or other alkali or alkaline earth metal salts thereof, or acid salts) also are suitable additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine.

Suitable polyamino acid additives include poly-L-aspartic acid, poly-L-lysine (e.g., poly-L-α-lysine or poly-L-ε-lysine), poly-L-omithine (e.g., poly-L-α-omithine or poly-L-ε-ornithine), poly-L-arginine, other polymeric forms of amino acids, and salt forms thereof (e.g., calcium, potassium, sodium, or magnesium salts such as L-glutamic acid mono sodium salt). The poly-amino acid additives also may be in the D- or L-configuration. Additionally, the poly-amino acids may be α-, β-, γ-, δ-, and ε-isomers if appropriate. Combinations of the foregoing poly-amino acids and their corresponding salts (e.g., sodium, potassium, calcium, magnesium salts or other alkali or alkaline earth metal salts thereof or acid salts) also are suitable additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to, poly-amino acids of various molecular weights (MVV), such as poly-L-α-lysine with a MW of 1,500, MW of 6,000, MW of 25,200, MW of 63,000, MW of 83,000, or MW of 300,000.

Suitable sugar acid additives include, but are not limited to, aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof.

Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable organic acid additives include any compound which comprises a —COOH moiety, such as, for example, C2-C30 carboxylic acids, substituted hydroxyl C2-C30 carboxylic acids, butyric acid (ethyl esters), substituted butyric acid (ethyl esters), benzoic acid, substituted benzoic acids (e.g., 2,4-dihydroxybenzoic acid), substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

Suitable organic acid additive salts include, but are not limited to, sodium, calcium, potassium, and magnesium salts of all organic acids, such as salts of citric acid, malic acid, tartaric acid, fumaric acid, lactic acid (e.g., sodium lactate), alginic acid (e.g., sodium alginate), gluconic acid (e.g., gluconate), ascorbic acid (e.g., sodium ascorbate), benzoic acid (e.g., sodium benzoate or potassium benzoate), sorbic acid and adipic acid. The examples of the organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phosphor or phosphonato. In particular embodiments, the organic acid additive is present in the sweetener composition in an amount effective to provide a concentration from about 10 ppm to about 5,000 ppm when present in a consumable, such as, for example, a beverage.

Suitable inorganic acid additives include, but are not limited to, phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

Suitable bitter compound additives include, but are not limited to, caffeine, quinine, urea, bitter orange oil, naringin, quassia, and salts thereof.

Suitable flavorants and flavoring ingredient additives include, but are not limited to, vanillin, vanilla extract, mango extract, cinnamon, citrus, coconut, ginger, viridiflorol, almond, menthol (including menthol without mint), grape skin extract, and grape seed extract. “Flavorant” and “flavoring ingredient” are synonymous and can include natural or synthetic substances or combinations thereof. Flavorants also include any other substance which imparts flavor and may include natural or non-natural (synthetic) substances which are safe for human or animals when used in a generally accepted range. Non-limiting examples of proprietary flavorants include Döhler™ Natural Flavoring Sweetness Enhancer K14323 (Döhler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, New Jersey, U.S.A.), and Sucramask™ (Creative Research Management, Stockton, California, U.S.A.).

Suitable polymer additives include, but are not limited to, chitosan, pectin, pectic, pectinic, polyuronic, polygalacturonic acid, starch, food hydrocolloid or crude extracts thereof (e.g., gum acacia senegal (Fibergum™), gum acacia seyal, carageenan), poly-L-lysine (e.g., poly-L-α-lysine or poly-L-ε-lysine), poly-L-omithine (e.g., poly-L-α-omithine or poly-L-ε-omithine), polypropylene glycol, polyethylene glycol, poly(ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

Suitable protein or protein hydrolysate additives include, but are not limited to, bovine serum albumin (BSA), whey protein (including fractions or concentrates thereof such as 90% instant whey protein isolate, 34% whey protein, 50% hydrolyzed whey protein, and 80% whey protein concentrate), soluble rice protein, soy protein, protein isolates, protein hydrolysates, reaction products of protein hydrolysates, glycoproteins, and/or proteoglycans containing amino acids (e.g., glycine, alanine, serine, threonine, asparagine, glutamine, arginine, valine, isoleucine, leucine, norvaline, methionine, proline, tyrosine, hydroxyproline, and the like), collagen (e.g., gelatin), partially hydrolyzed collagen (e.g., hydrolyzed fish collagen), and collagen hydrolysates (e.g., porcine collagen hydrolysate).

Suitable surfactant additives include, but are not limited to, polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltrimethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and other emulsifiers, and the like.

Suitable flavonoid additives are classified as flavonols, flavones, flavanones, flavan-3-ols, isoflavones, or anthocyanidins. Non-limiting examples of flavonoid additives include, but are not limited to, catechins (e.g., green tea extracts such as Polyphenon™ 60, Polyphenon™ 30, and Polyphenon™ 25 (Mitsui Norin Co., Ltd., Japan), polyphenols, rutins (e.g., enzyme modified rutin Sanmelin™ AO (San-fi Gen F.F.I., Inc., Osaka, Japan)), neohesperidin, naringin, neohesperidin dihydrochalcone, and the like.

Suitable alcohol additives include, but are not limited to, ethanol.

Suitable astringent compound additives include, but are not limited to, tannic acid, europium chloride (EuCl₃), gadolinium chloride (GdCl₃), terbium chloride (TbCl₃), alum, tannic acid, and polyphenols (e.g., tea polyphenols).

### III. Methods

Methods of preparing enhanced water beverages of the present invention are also provided.

In one embodiment, a method of preparing a beverage comprises combining a beverage matrix with (a) a steviol glycoside composition comprising a steviol glycoside in an amount of about 95% or greater by weight on a dry basis; (b) a mogroside composition selected from the group consisting of (i) monk fruit concentrate comprising at least 3.5 wt % mogroside V, (ii) siamenoside 1, or (iii) monk fruit extract comprising about 45% or greater mogroside V by weight on a dry basis; (c) a miracle fruit composition in a concentration of about 5 ppm to about 60 ppm; and (d) at least one vitamin and/or electrolyte.

### EXAMPLES

### Materials and Methods

Food grade ingredients with different purity were acquired from different suppliers: stevia leaf extract rebaudioside A 95 (purity on dry basis: reb A≥95%, TSG>95%), rebaudioside A 99 (purity on dry basis: reb A≥97%, TSG>99%); Monk fruit extract 50 (purity on dry basis: 48-52% mogroside V, ≥94% monk fruit extract); Monk fruit extract 80 (purity ≥78% Mogroside V), Monk fruit juice concentrate (65°Brix, 3.5% Mogroside V, 75% monk fruit solids), Siamenoside I (purity on dry basis: ≥95% siamenoside-1, >95% extract; sourced from Glycosyn, New Zealand). Freeze-dry Miracle fruit powder was sourced from Miracle Fruit Farm, Miami, US.

### Beverage Production

The ingredients were dissolved in filtered water until complete dissolution. Each final batch was heated until on hot plate under stirring until the temperature reaches 82.2° C. then hot-filled in 300 ml PET bottles and cooled in ice water. Beverages were stored in refrigerator until taste test at cold (4° C.). Beverage brix was 0.7-1.03°, titratable acidity was 0.093-0.27% w/v as citric acid, while pH was 3.2.

### Example 1: Beverages Sweetened with Stevia Leaf Extract (Reb A 95)

Beverages were prepared with the ingredients described in Tables 1 and 2.

TABLE 1
Acai Blueberry Pomegranate Flavored Water Zero Sugar Composition

| Ingredients | V1 | V2 | V3 | V4 | V5 | V6 | V7 | V8 | V9 | V10 | V11 |
|---|---|---|---|---|---|---|---|---|---|---|---|
| Filtered water | 991.5 | 992.5 | 992.5 | 992.5 | 992.4 | 992.5 | 992.5 | 992.4 | 992.4 | 992.4 | 992.4 |
| Erythritol | 5 | 5 | 5 | 5 | 5 | 5 | 5 | 5 | 5 | 5 | 5 |
| Vitamin & | 0.285 | 0.285 | 0.285 | 0.285 | 0.285 | 0.285 | 0.285 | 0.285 | 0.285 | 0.285 | 0.285 |
| mineral | | | | | | | | | | | |
| premix (Vit | | | | | | | | | | | |
| B5, B6, B12; | | | | | | | | | | | |
| Mg, Ca, K) | | | | | | | | | | | |
| Beta carotene | 0.012 | 0.012 | 0.012 | 0.012 | 0.012 | 0.012 | 0.012 | 0.012 | 0.012 | 0.012 | 0.012 |
| 15% | | | | | | | | | | | |
| Manganese | 0.004 | 0.004 | 0.004 | 0.004 | 0.004 | 0.004 | 0.004 | 0.004 | 0.004 | 0.004 | 0.004 |
| citrate | | | | | | | | | | | |
| Sodium | 0.006 | 0.006 | 0.006 | 0.006 | 0.006 | 0.006 | 0.006 | 0.006 | 0.006 | 0.006 | 0.006 |
| selenate 1% | | | | | | | | | | | |
| Citric acid | 0.637 | 0.637 | 0.637 | 0.637 | 0.637 | 0.637 | 0.637 | 0.637 | 0.637 | 0.637 | 0.637 |
| Ascorbic acid | 0.683 | 0.683 | 0.683 | 0.683 | 0.683 | 0.683 | 0.683 | 0.683 | 0.683 | 0.683 | 0.683 |
| Flavor | 0.615 | 0.615 | 0.615 | 0.615 | 0.615 | 0.615 | 0.615 | 0.615 | 0.615 | 0.615 | 0.615 |
| Fruit & | 0.693 | 0.693 | 0.693 | 0.693 | 0.693 | 0.693 | 0.693 | 0.693 | 0.693 | 0.693 | 0.693 |
| vegetable | | | | | | | | | | | |
| color | | | | | | | | | | | |
| Stevia Reb-A | 0.18 | 0.15 | 0.15 | 0.15 | 0.15 | 0.15 | 0.15 | 0.15 | 0.15 | 0.15 | 0.15 |
| 95 | | | | | | | | | | | |
| Monk fruit | — | 0.025 | 0.05 | 0.075 | 0.1 | 0.025 | 0.05 | 0.075 | 0.1 | 0.1 | 0.1 |
| extract 50 | | | | | | | | | | | |
| Miracle fruit | — | — | — | — | — | 0.01 | 0.01 | 0.01 | 0.01 | 0.025 | 0.05 |
| powder | | | | | | | | | | | |
| TOTAL | 1000 | 1000 | 1000 | 1000 | 1000 | 1000 | 1000 | 1000 | 1000 | 1000 | 1000 |
| (grams) | | | | | | | | | | | |

TABLE 2
Lemonade Flavored Water Zero Sugar Composition

| Ingredients | V1 | V2 | V3 | V4 | V5 | V6 | V7 | V8 | V9 | V10 | V11 |
|---|---|---|---|---|---|---|---|---|---|---|---|
| Filtered water | 990.3 | 990.3 | 990.3 | 990.3 | 990.3 | 990.3 | 990.2 | 990.2 | 990.2 | 990.2 | 990.2 |
| Erythritol | 5 | 5 | 5 | 5 | 5 | 5 | 5 | 5 | 5 | 5 | 5 |
| Citric acid | 0.467 | 0.467 | 0.467 | 0.467 | 0.467 | 0.467 | 0.467 | 0.467 | 0.467 | 0.467 | 0.467 |
| Ascorbic acid | 0.303 | 0.303 | 0.303 | 0.303 | 0.303 | 0.303 | 0.303 | 0.303 | 0.303 | 0.303 | 0.303 |
| Vitamin & | 0.2 | 0.2 | 0.2 | 0.2 | 0.2 | 0.2 | 0.2 | 0.2 | 0.2 | 0.2 | 0.2 |
| Mineral blend | | | | | | | | | | | |
| (Vit B5, B6; | | | | | | | | | | | |
| Mg, K, Ca) | | | | | | | | | | | |
| Vitamin E | 0.042 | 0.042 | 0.042 | 0.042 | 0.042 | 0.042 | 0.042 | 0.042 | 0.042 | 0.042 | 0.042 |
| 50% | | | | | | | | | | | |
| Monocalcium | 1.936 | 1.936 | 1.936 | 1.936 | 1.936 | 1.936 | 1.936 | 1.936 | 1.936 | 1.936 | 1.936 |
| phosphate | | | | | | | | | | | |
| Vitamin A | 0.008 | 0.008 | 0.008 | 0.008 | 0.008 | 0.008 | 0.008 | 0.008 | 0.008 | 0.008 | 0.008 |
| Magnesium | 0.799 | 0.799 | 0.799 | 0.799 | 0.799 | 0.799 | 0.799 | 0.799 | 0.799 | 0.799 | 0.799 |
| lactate | | | | | | | | | | | |
| Zinc gluconate | 0.045 | 0.045 | 0.045 | 0.045 | 0.045 | 0.045 | 0.045 | 0.045 | 0.045 | 0.045 | 0.045 |
| Sodium | 0.006 | 0.006 | 0.006 | 0.006 | 0.006 | 0.006 | 0.006 | 0.006 | 0.006 | 0.006 | 0.006 |
| selenate 1% | | | | | | | | | | | |
| Niacinamide | 0.037 | 0.037 | 0.037 | 0.037 | 0.037 | 0.037 | 0.037 | 0.037 | 0.037 | 0.037 | 0.037 |
| d-Biotin 1% | 0.002 | 0.002 | 0.002 | 0.002 | 0.002 | 0.002 | 0.002 | 0.002 | 0.002 | 0.002 | 0.002 |
| Phosphoric | 0.296 | 0.296 | 0.296 | 0.296 | 0.296 | 0.296 | 0.296 | 0.296 | 0.296 | 0.296 | 0.296 |
| acid | | | | | | | | | | | |
| Lemon flavor | 0.41 | 0.41 | 0.41 | 0.41 | 0.41 | 0.41 | 0.41 | 0.41 | 0.41 | 0.41 | 0.41 |
| emulsion | | | | | | | | | | | |
| Stevia Reb-A | 0.18 | 0.15 | 0.15 | 0.15 | 0.15 | 0.15 | 0.15 | 0.15 | 0.15 | 0.15 | 0.15 |
| 95 | | | | | | | | | | | |
| Monk fruit | — | 0.025 | 0.05 | 0.075 | 0.1 | 0.025 | 0.05 | 0.075 | 0.1 | 0.1 | 0.1 |
| extract 50 | | | | | | | | | | | |
| Miracle fruit | — | — | — | — | — | 0.01 | 0.01 | 0.01 | 0.01 | 0.025 | 0.05 |
| powder | | | | | | | | | | | |
| TOTAL | 1000 | 1000 | 1000 | 1000 | 1000 | 1000 | 1000 | 1000 | 1000 | 1000 | 1000 |
| (grams) | | | | | | | | | | | |

### Sensory Evaluation

The beverages were evaluated blindly by eight expert panelists. Samples were coded and randomly presented to the panelists. Panelists were instructed to eat an unsalted cracker and rinse the mouth with water before and in between samples. The maximum number of samples for each session was set at 6 samples to avoid fatigue. For each sample, panelists were instructed to take 3 sips, then write down their evaluation comments.

### Sensory Results

TABLE 3
Acai Blueberry Pomegranate Flavored Water Zero Sugar

| | | | | | Rank as per |
|---|---|---|---|---|---|
| | | | | | sensory |
| | | | | | preference |
| | | Sweetener | | | (group |
| Version | Sweeteners | Level | | Sensory Notes | consensus) |
| 1 | Reb-A 95 | 180 | ppm | Nice flavor but get a strong | 10 |
| | | | | lingering sweetener aftertaste | |
| 2 | Reb-A 95 | 150 | ppm | Much less aftertaste than version 1 | 11 |
| | Monk Fruit | 25 | ppm | but still noticeable | |
| | extract 50 | | | | |
| 3 | Reb-A 95 | 150 | ppm | Flavor coming through better than | 8 |
| | Monk Fruit | 50 | ppm | version 1 and 2. No aftertaste. | |
| | extract 50 | | | | |
| 4 | Reb-A 95 | 150 | ppm | Most preferred amongst the Stevia | 7 |
| | Monk Fruit | 75 | ppm | and Monk fruit combination | |
| | extract 50 | | | variables. Very good level of | |
| | | | | sweetness and flavor. Minimal to | |
| | | | | no aftertaste | |
| 5 | Reb-A 95 | 150 | ppm | Good flavor coming through but | 9 |
| | Monk Fruit | 100 | ppm | too much sweetness from the | |
| | extract 50 | | | Stevia and Monk fruit which was | |
| | | | | not desirable. No aftertaste. | |
| 6 | Reb-A 95 | 150 | ppm | Good sweet berry flavor upfront | 6 |
| | Monk Fruit | 25 | ppm | with no aftertaste. Flavor and | |
| | extract 50 | | | sweetness carrying through till the | |
| | Miracle fruit | 10 | ppm | end. But needs more flavor and | |
| | powder | | | sweetness to come through. No | |
| | | | | aftertaste. | |
| 7 | Reb-A 95 | 150 | ppm | Very positively received. Very | 2 |
| | Monk Fruit | 50 | ppm | good berry flavor and sweetness. | |
| | extract 50 | | | Most liked amongst all variables | |
| | Miracle fruit | 10 | ppm | tasted so far. No aftertaste. | |
| | powder | | | | |
| 8 | Reb-A 95 | 150 | ppm | Most preferred variable amongst | 1 |
| | Monk Fruit | 75 | ppm | all. Liked it better than control. | |
| | extract 50 | | | Very good finish at the end with | |
| | Miracle fruit | 10 | ppm | very bright fresh berry flavor. | |
| | powder | | | Panelist thought this level of | |
| | | | | sweetener helps bring out the best | |
| | | | | berry flavor profile. No aftertaste. | |
| 9 | Reb-A 95 | 150 | ppm | Very positively received. Very | 3 |
| | Monk Fruit | 100 | ppm | good berry flavor and sweetness. | |
| | extract 50 | | | A little bit too sweet for a few | |
| | Miracle fruit | 10 | ppm | panelists. No aftertaste. | |
| | powder | | | | |
| 10 | Reb-A 95 | 150 | ppm | Well received sample. Higher on | 4 |
| | Monk Fruit | 100 | ppm | sweetness as compared to | |
| | extract 50 | | | previous samples. Panelists | |
| | Miracle fruit | 25 | ppm | thought the sweetness was | |
| | powder | | | overpowering the flavor a bit. No | |
| | | | | aftertaste. | |
| 11 | Reb-A 95 | 150 | ppm | Well received sample. Higher on | 5 |
| | Monk Fruit | 100 | ppm | sweetness as compared to | |
| | extract 50 | | | previous samples. Panelists | |
| | Miracle fruit | 50 | ppm | thought the sweetness was | |
| | powder | | | overpowering the flavor a bit. No | |
| | | | | aftertaste. | |

TABLE 4
Lemonade Flavored Water Zero Sugar

| | | | | | Rank as per |
|---|---|---|---|---|---|
| | | | | | sensory |
| | | | | | preference |
| | | | | | (group |
| Version | Sweeteners | Level | | Sensory Notes | consensus) |
| 1 | Reb-A 95 | 180 | ppm | Nice flavor but get a strong | 10 |
| | | | | lingering sweetener aftertaste | |
| 2 | Reb-A 95 | 150 | ppm | Much less aftertaste than version 1 | 11 |
| | Monk Fruit | 25 | ppm | but still noticeable | |
| | extract 50 | | | | |
| 3 | Reb-A 95 | 150 | ppm | Flavor coming through better than | 8 |
| | Monk Fruit | 50 | ppm | version 1 and 2. No aftertaste. | |
| | extract 50 | | | | |
| 4 | Reb-A 95 | 150 | ppm | Most preferred amongst the Stevia | 7 |
| | Monk Fruit | 75 | ppm | and Monk fruit combination | |
| | extract 50 | | | variables. Very good level of | |
| | | | | sweetness and flavor. Minimal to | |
| | | | | no aftertaste | |
| 5 | Reb-A 95 | 150 | ppm | Good flavor coming through but | 9 |
| | Monk Fruit | 100 | ppm | too much sweetness from the | |
| | extract 50 | | | Stevia and Monk fruit which was | |
| | | | | not desirable. No aftertaste. | |
| 6 | Reb-A 95 | 150 | ppm | Good sweet lemonade flavor | 6 |
| | Monk Fruit | 25 | ppm | upfront with no aftertaste. Flavor | |
| | extract 50 | | | and sweetness carrying through till | |
| | Miracle fruit | 10 | ppm | the end. But needs more flavor | |
| | powder | | | and sweetness to come through. | |
| | | | | No aftertaste. | |
| 7 | Reb-A 95 | 150 | ppm | Very positively received. Very | 2 |
| | Monk Fruit | 50 | ppm | good lemonade flavor and | |
| | extract 50 | | | sweetness. Most liked amongst all | |
| | Miracle fruit | 10 | ppm | variables tasted so far. No | |
| | powder | | | aftertaste. | |
| 8 | Reb-A 95 | 150 | ppm | Most preferred variable amongst | 1 |
| | Monk Fruit | 75 | ppm | all. Liked it better than control. | |
| | extract 50 | | | Very good finish at the end with | |
| | Miracle fruit | 10 | ppm | very fresh lemonade flavor. | |
| | powder | | | Panelist thought this level of | |
| | | | | sweetener helps bring out the best | |
| | | | | flavor profile. No aftertaste. | |
| 9 | Reb-A 95 | 150 | ppm | Very positively received. Very | 3 |
| | Monk Fruit | 100 | ppm | good lemonade flavor and | |
| | extract 50 | | | sweetness. A little bit too sweet for | |
| | Miracle fruit | 10 | ppm | a few panelists. No aftertaste. | |
| | powder | | | | |
| 10 | Reb-A 95 | 150 | ppm | Well received sample. Higher on | 4 |
| | Monk Fruit | 100 | ppm | sweetness as compared to | |
| | extract 50 | | | previous samples. Panelists | |
| | Miracle fruit | 25 | ppm | thought the sweetness was | |
| | powder | | | overpowering the flavor a bit. No | |
| | | | | aftertaste. | |
| 11 | Reb-A 95 | 150 | ppm | Well received sample. Higher on | 5 |
| | Monk Fruit | 100 | ppm | sweetness as compared to | |
| | extract 50 | | | previous samples. Panelists | |
| | Miracle fruit | 50 | ppm | thought the sweetness was | |
| | powder | | | overpowering the flavor a bit. No | |
| | | | | aftertaste. | |

Sensory results show that the best blend imparting best taste for both flavors (acai blueberry pomegranate as well as lemonade) was Reb-A 95 (150 ppm)+Monk fruit extract 50 (75 ppm)+Miracle fruit powder (10 ppm). This blend was the most preferred by panelists among all the samples.

### Example 2: Beverages Sweetened with Stevia Leaf Extract (Reb A 99)

Beverages were prepared with the ingredients described in Tables 5 and 6.

TABLE 5
Acai Blueberry Pomegranate Flavored
Water Zero Sugar Composition

| Ingredients | Control | V1 | V2 | V3 |
|---|---|---|---|---|
| Filtered water | 991.83 | 991.83 | 991.83 | 991.83 |
| Erythritol | 5 | 5 | 5 | 5 |
| Vitamin & mineral | 0.285 | 0.285 | 0.285 | 0.285 |
| premix (Vit B5, B6, | | | | |
| B12; Mg, Ca, K) | | | | |
| Beta carotene 15% | 0.012 | 0.012 | 0.012 | 0.012 |
| Manganese citrate | 0.004 | 0.004 | 0.004 | 0.004 |
| Sodium selenate 1% | 0.006 | 0.006 | 0.006 | 0.006 |
| Citric acid | 0.637 | 0.637 | 0.637 | 0.637 |
| Ascorbic acid | 0.683 | 0.683 | 0.683 | 0.683 |
| Flavor | 0.615 | 0.615 | 0.615 | 0.615 |
| Fruit & vegetable color | 0.693 | 0.693 | 0.693 | 0.693 |
| Stevia Reb-A 95 | 0.15 | — | — | — |
| Stevia Reb-A 99 | — | 0.15 | 0.15 | 0.15 |
| Monk fruit extract 50 | 0.075 | 0.075 | — | — |
| Monk fruit extract 80 | — | — | 0.075 | — |
| Siamenoside-I | — | — | — | 0.075 |
| Miracle fruit powder | 0.01 | 0.01 | 0.01 | 0.01 |
| TOTAL (grams) | 1000 | 1000 | 1000 | 1000 |

TABLE 6
Lemonade Flavored Water Zero Sugar Composition

| Ingredients | Control | V1 | V2 | V3 | V4 |
|---|---|---|---|---|---|
| Filtered water | 990.21 | 990.21 | 990.21 | 989.19 | 990.21 |
| Erythritol | 5 | 5 | 5 | 5 | 5 |
| Citric acid | 0.467 | 0.467 | 0.467 | 0.467 | 0.467 |
| Ascorbic acid | 0.303 | 0.303 | 0.303 | 0.303 | 0.303 |
| Vitamin & Mineral blend | 0.2 | 0.2 | 0.2 | 0.2 | 0.2 |
| (Vit B5, B6; Mg, K, Ca) | | | | | |
| Vitamin E 50% | 0.042 | 0.042 | 0.042 | 0.042 | 0.042 |
| Monocalcium phosphate | 1.936 | 1.936 | 1.936 | 1.936 | 1.936 |
| Vitamin A | 0.008 | 0.008 | 0.008 | 0.008 | 0.008 |
| Magnesium lactate | 0.799 | 0.799 | 0.799 | 0.799 | 0.799 |
| Zinc gluconate | 0.045 | 0.045 | 0.045 | 0.045 | 0.045 |
| Sodium selenate 1% | 0.006 | 0.006 | 0.006 | 0.006 | 0.006 |
| Niacinamide | 0.037 | 0.037 | 0.037 | 0.037 | 0.037 |
| d-Biotin 1% | 0.002 | 0.002 | 0.002 | 0.002 | 0.002 |
| Phosphoric acid | 0.296 | 0.296 | 0.296 | 0.296 | 0.296 |
| Lemon flavor emulsion | 0.41 | 0.41 | 0.41 | 0.41 | 0.41 |
| Stevia Reb-A 95 | 0.15 | — | — | — | — |
| Stevia Reb-A 99 | — | 0.15 | 0.15 | 0.15 | 0.15 |
| Monk fruit extract 50 | 0.075 | 0.075 | — | — | — |
| Monk fruit extract 80 | — | — | 0.075 | — | — |
| Monk fruit juice concentrate | — | — | — | 1.1 | — |
| Siamenoside-I | — | — | — | — | 0.075 |
| Miracle fruit powder | 0.01 | 0.01 | 0.01 | 0.01 | 0.01 |
| TOTAL (grams) | 1000 | 1000 | 1000 | 1000 | 1000 |

### Sensory Evaluation

The beverages were evaluated blindly by eight expert panelists. Samples were coded and randomly presented to the panelists. Panelists were instructed to eat an unsalted cracker and rinse the mouth with water before and in between samples. The maximum number of samples for each session was set at 6 samples to avoid fatigue. For each sample, panelists were instructed to take 3 sips, then write down their evaluation comments.

TABLE 7
Acai Blueberry Pomegranate Flavored Water Zero Sugar

| | | | | | Rank as per |
|---|---|---|---|---|---|
| | | | | | sensory |
| | | | | | preference |
| | | | | | (group |
| Version | Sweeteners | Level | | Sensory Notes | consensus) |
| Control | Reb-A 95 | 150 | ppm | Most preferred variable | 1 |
| | Monk Fruit | 75 | ppm | amongst all. Very good finish at | |
| | extract 50 | | | the end with very bright fresh | |
| | Miracle fruit | 10 | ppm | berry flavor. Panelist thought | |
| | powder | | | this level of sweetener helps | |
| | | | | bring out the best berry flavor | |
| | | | | profile. No aftertaste. | |
| V1 | Reb-A 99 | 150 | ppm | Most preferred out of V1-3 | 2 |
| | Monk Fruit | 75 | ppm | samples. But still not as good | |
| | extract 50 | | | as control. Tastes very good. | |
| | Miracle fruit | 10 | ppm | Nice berry flavor coming | |
| | powder | | | through but still not as good as | |
| | | | | control | |
| V2 | Reb-A 99 | 150 | ppm | Sweeter than control and V1. | 4 |
| | Monk Fruit | 75 | ppm | Had a very artificial sweet | |
| | extract 80 | | | taste. Some panelists thought | |
| | Miracle fruit | 10 | ppm | the sample tasted watery. | |
| | powder | | | Overall taste was acceptable | |
| V3 | Reb-A 99 | 150 | ppm | Too sweet for the panelists. | 3 |
| | Siamenoside -I | 75 | ppm | The flavor, acidity and | |
| | Miracle fruit | 10 | ppm | sweetness balance was | |
| | powder | | | disturbed due to increased | |
| | | | | sweetness. Overall taste was | |
| | | | | acceptable | |

In this complex flavor example, the control with blend of 150 ppm Reb-A 95+75 ppm Monk fruit extract 50+10 ppm Miracle fruit powder was the most preferred among the four combinations.

TABLE 8
Lemonade Flavored Water Zero Sugar

| | | | | | Rank as per |
|---|---|---|---|---|---|
| | | | | | sensory |
| | | | | | preference |
| | | | | | (group |
| Version | Sweeteners | Level | | Sensory Notes | consensus) |
| Control | Reb-A 95 | 150 | ppm | Sweet lemon, fruity | 3 |
| | Monk Fruit | 75 | ppm | flavor with a clean and | |
| | extract 50 | | | sweeter finish than | |
| | Miracle fruit | 10 | ppm | Stevia + Monk fruit | |
| | powder | | | version without Miracle | |
| | | | | fruit powder | |
| V1 | Reb-A 99 | 150 | ppm | Well received. Tastes | 2 |
| | Monk Fruit extract 50 | 75 | ppm | like having sugar. No | |
| | Miracle fruit powder | 10 | ppm | aftertaste | |
| V2 | Reb-A 99 | 150 | ppm | Most preferred sample. | 1 |
| | Monk Fruit extract 80 | 75 | ppm | Tastes like base | |
| | Miracle fruit powder | 10 | ppm | Vitaminwater. Very well | |
| | | | | balanced | |
| V3 | Reb-A 99 | 150 | ppm | Good flavor. No | 4 |
| | Monk Fruit juice | 0.11% | | aftertaste. But a little | |
| | concentrate | | | too sweet. Sweetness | |
| | Miracle fruit powder | 10 | ppm | is a little overpowering. | |
| | | | | Overall taste is | |
| | | | | acceptable | |
| V4 | Reb-A 99 | 150 | ppm | Least preferred among | 5 |
| | Siamenoside -I | 75 | ppm | the batch. Overall taste | |
| | Miracle fruit powder | 10 | ppm | is acceptable but still | |
| | | | | high on the sweetness | |

The blend of 150 ppm Reb-A 99+75 ppm Monk fruit extract 80+10 ppm Miracle fruit powder was the most preferred among the four combinations.

1. An enhanced water beverage comprising:
a. a steviol glycoside composition comprising a steviol glycoside in an amount of about 80% or greater by weight on a dry basis;
b. a mogroside composition selected from the group consisting of (i) monk fruit concentrate comprising at least 3.5 wt % mogroside V, (ii) siamenoside I, or (iii) monk fruit extract comprising about 45% or greater mogroside V by weight on a dry basis;
c. a miracle fruit composition in a concentration of about 5 ppm to about 60 ppm; and
d. at least one vitamin and/or electrolyte;
wherein the steviol glycoside composition and the mogroside composition are present in a weight ratio of about 3:1 to about 1.5:1 when the mogroside composition is (ii) or (iii), and
when the mogroside composition is (ii), the monk fruit concentrate comprising at least 3.5 wt % mogroside V is present in an amount of about 0.1 to about 0.20% by weight on a dry basis.

2. The enhanced water beverage of claim 1, wherein the steviol glycoside is selected from the group consisting of rebaudioside A, rebaudioside M, rebaudioside D, rebaudioside N, rebaudioside O, rebaudioside E, steviolmonoside, steviolbioside, rubusoside, dulcoside B, dulcoside A, rebaudioside B, rebaudioside G, stevioside, rebaudioside C, rebaudioside F, rebaudioside I, rebaudioside H, rebaudioside L, rebaudioside K, rebaudioside J, rebaudioside M2, rebaudioside D2, rebaudioside S, rebaudioside T, rebaudioside U, rebaudioside V, rebaudioside W, rebaudioside Z1, rebaudioside Z2, rebaudioside IX, and stevioside.

3. The enhanced water beverage of claim 1, wherein the steviol glycoside is rebaudioside A.

4. The enhanced water beverage of claim 1, wherein the steviol glycoside composition is present in the beverage in a concentration from about 50 ppm to about 200 ppm.

5. The enhanced water beverage of claim 1, wherein the mogroside composition is (ii) or (iii) and is present in the beverage in a concentration from about 20 ppm to about 100 ppm.

6. The enhanced water beverage of claim 1, wherein the miracle fruit composition is miracle fruit powder.

7. The enhanced water beverage of claim 1, wherein the miracle fruit composition is present in a concentration of from about 5 ppm to about 25 ppm.

8. The enhanced water beverage of claim 1, wherein the vitamin is selected from the group consisting of vitamin A, vitamin D, vitamin E, vitamin K, vitamin B1, vitamin B2, vitamin B3, vitamin B5, vitamin B6, vitamin B7, vitamin B9, vitamin B12, vitamin C, and combinations thereof.

9. The enhanced water beverage of claim 1, wherein the electrolyte is selected from the group consisting of sodium, potassium, calcium, magnesium, chloride, phosphate, bicarbonate, citrate, lactate, gluconate and combinations thereof.

10. The enhanced water beverage of claim 1, further comprising at least one flavor.

11. The enhanced water beverage of claim 10, wherein the flavor is selected from the group consisting of agai, apple, apricot, avocado, banana, blackberry, black currant, blueberry, breadfruit, cantaloupe, carambola, cherimoya, cherry, clementine, coconut, cranberry, custard-apple, date, dragonfruit, durian, elderberry, feijoa, fig, gooseberry, grapefruit, grape, guava, honeydew melon, jackfruit, java-plum, jujube fruit, kiwifruit, kumquat, lemon, lime, longan, loquat, lychee, mandarin, mango, mangosteen, mulberry, nectarine, orange, papaya, passion fruit, peach, pear, persimmon, pitaya (dragonfruit), pineapple, pitanga, plantain, plum, pomegranate, prickly pear, prune, pummelo, quince, raspberry, rhubarb, rose-apple, sapodilla, sapote, soursop, strawberry, sugar-apple, tamarine, tangerine, watermelon, chamomile, peppermint, hibiscus, lavender, marigold, chrysanthemum, ginger, turmeric, and combinations thereof.

12. The enhanced water beverage of claim 1, wherein beverage has a sucrose equivalence of from about 0.7% to about 1.5%.

13. The enhanced water beverage of claim 1, wherein the beverage does not contain sucrose.

14. The enhanced water beverage of claim 1, wherein the beverage has from 0 to about 5 calories per 20 US fluid ounce serving.

15. The enhanced water beverage of claim 1, wherein the steviol glycoside composition comprises rebaudioside A, the mogroside composition comprises monk fruit extract, and the miracle fruit composition comprises miraculin.

16. The enhanced water beverage of claim 1, wherein the steviol glycoside composition comprises rebaudioside A in an amount of about 90% to about 99% by weight on a dry basis.

17. The enhanced water beverage of claim 1, wherein the steviol glycoside composition comprising rebaudioside A is present in the enhanced water beverage in an amount in the range of about 125 ppm to about 175 ppm.

18. The enhanced water beverage of claim 1, wherein the mogroside composition comprises monk fruit extract which comprises mogroside V in an amount of about 45% to about 85% by weight on a dry basis.

19. The enhanced water beverage of claim 1, wherein the miracle fruit composition comprises miracle fruit powder in an amount of about 5 to about 25 ppm.

20. A method of preparing a beverage, the method comprising: combining a beverage matrix with (a) a steviol glycoside composition comprising a steviol glycoside in an amount of about 95% or greater by weight on a dry basis; (b) a mogroside composition selected from the group consisting of (i) monk fruit concentrate comprising at least 3.5 wt % mogroside V, (ii) siamenoside I, or (iii) monk fruit extract comprising about 45% or greater mogroside V by weight on a dry basis; (c) a miracle fruit composition in a concentration of about 5 ppm to about 60 ppm; and (d) at least one vitamin and/or electrolyte.
